(19) United States
(12) Patent Application Publication
(10) Pub. No.: US 2010/0103649 A1
(43) Pub. Date: Apr. 29, 2010

(54) LIGHT SOURCE MODULE AND BACKLIGHT LIGHT SOURCE

(76) Inventor: Tetsuya Hamada, Osaka (JP)

Correspondence Address: BIRCH STEWART KOLASCH & BIRCH, PO BOX 747, FALLS CHURCH, VA, 22040-0747, US

(21) Appl. No.: 12/523,944

(22) PCT Filed: Aug. 21, 2007
(86) PCT No.: PCT/JP2007/066141

§ 371 Date: Jul. 21, 2009

(30) Foreign Application Priority Data
Jan. 22, 2007 (JP) 2007-011655

(51) Int. Cl. G02F 1/13357; F21S 4/00

(52) U.S. Cl. 362/97.1; 362/249.01

(57) ABSTRACT

A light source module (1) is constituted by forming lines (13a, 13b) on a mounting substrate (11) and a connection substrate (12) integrally formed of a flexible material, and mounting a first connector (15), a second connector (16), and a plurality of LEDs (18) on the substrates. The connection substrate of one of adjoining light source modules is connected with the first connector (15) of the other light source module, thereby connecting a plurality of light source modules (1) linearly. In the light source module (1) at the end, terminals (14a, 14b) of the connection substrate (12) are connected with the second connector (16) while being reversed, thereby interconnecting two lines (13a, 14b). A plurality of light source modules (1) can thereby be connected without using a separate component such as a wire harness.

### TECHNICAL FIELD

The present invention relates to a light source module and a backlight light source that are employed in, for example, a liquid crystal display device.

### BACKGROUND ART

Conventionally, as backlight light sources for liquid crystal display devices, there are known backlight light sources that have a plurality of LEDs (light emitting diodes) mounted in a matrix on a mounting substrate and that are disposed on the back surface side of a liquid crystal display panel (see, e.g., Patent Document 1). As mounting substrates for such backlight light sources, aluminum substrates and glass epoxy substrates are widely used; typically, a single substrate roughly the same size as the liquid crystal display panel is used.

These days, as liquid crystal display devices are made increasingly large, mounting substrates for backlight light sources are made accordingly large. This may increase the number of LEDs mounted on a single mounting substrate, diminishing the yields of backlight light source. Thus, there are backlight light sources in which a smaller number of LEDs are mounted on a small-size mounting substrate to form a light source module, and a plurality of such light source modules are connected together with wire harnesses, so as to cope with large liquid crystal display devices.

However, backlight light sources in which a plurality of light source modules are connected together with wire harnesses requires a plurality of wire harnesses, and this inconveniently increases the number of components and complicates the manufacturing process, resulting in increased cost.

### Patent Document 1: JP-A-2004-191490 Publication

### DISCLOSURE OF THE INVENTION

### Problems to be Solved by the Invention

Thus, an object of the present invention is to provide a light source module and a backlight light source that, even when used in large-size display devices, can prevent a lowering in yield, and that in addition can prevent increases in the number of components and in cost.

### Means for Solving the Problem

To solve the above problems, a light source module according to the present invention is provided with: a mounting substrate that has a conductor; a connection substrate that is formed integral with the mounting substrate and that has a terminal connected to one end of the conductor; a plurality of light sources that are mounted on the mounting substrate; and a first connector that is mounted on the mounting substrate, that is connected to the other end of the conductor, and to which a connection substrate shaped identically with the connection substrate can be connected.

With the structure described above, by preparing a plurality of light source modules and connecting the connection substrate of one light source module to the first connector of the next, it is possible to connect the plurality of light source modules linearly together. By using the plurality of light source modules linearly connected together as a backlight light source, it is possible to build a backlight for display devices. In the light source module according to the invention, the mounting substrate and the connection substrate are formed integral with each other, and thus the plurality of light source modules can be connected one to the next without using separate members such as wire harnesses. It is therefore possible to reduce the number of light sources per one light module to prevent a lowering in yield, and at the same time to form a backlight, with a smaller number of components and reduced cost, that can cope with large-size display devices.

Moreover, by adjusting the number of light source modules connected together, it is possible to form a plurality of backlight light sources in different sizes; thus it is possible to make light source modules versatile and achieve cost reduction more effectively.

In a case where the plurality of light sources included in the plurality of light source modules linearly connected together are controlled in a plurality of channels, if two adjacent light source modules are connected together with a wire harness, a plurality of wire harnesses corresponding to the number of channels are required. In contrast, with the light source module according to the present invention, by previously forming conductors and terminals for the plurality of channels on the mounting substrate and the connection substrate, it is possible to connect two adjacent light source modules with one connection substrate. It is therefore possible to effectively cut down the trouble of connecting a plurality of light source modules together and the number of components required.

In the light source module according to one embodiment of the invention, the mounting substrate and the connection substrate are flexible.

According to the above-described embodiment, when the plurality of light source modules are connected with each other, since the mounting substrate and the connection substrate formed integral with each other are flexible, they allow easy connection. Here, it is preferable that the mounting substrate and the connection substrate be formed of for example, a resin material such as polyimide.

In the light source module according to one embodiment of the invention, the mounting substrate has a plurality of conductors, and a second connector is provided that permits the connection substrate formed integral with the mounting substrate to be connected to the plurality of conductors somewhere therealong.

According to the above-described embodiment, by connecting the connection substrate to the second connector on the mounting substrate integral with itself, it is possible to connect at least two of the plurality of conductors with one another. Therefore, to the other end of the at least two conductors connected together, a driver circuit of the light sources can be collectively connected. As a result, to the end of the light source module where the first connector is provided, the conductors for driving the light source module can be collectively connected; this helps simplify the wiring structure and facilitate wiring.

Here, to connect together at least two of the plurality of conductors, for example, one way is to fold the connection substrate, with the positions of the terminals on the connection substrate reversed, and connect it to the second connector, and another way is to reverse the positions of the terminal electrodes on the second connector from those of the terminals on the connection substrate.

In the light source module according to one embodiment of the invention, the light sources are LEDs.

According to the above-described embodiment, by employing LEDs as light sources, it is possible to obtain light source modules with long lifetimes.

The backlight light source according to the invention is provided with a plurality of light source modules as described above, in which the plurality of light source modules are so formed as to be linearly connected together with the connection substrate and the first connector connected together between every two adjacent light source modules.

With the structure described above, it is possible to obtain a backlight light source with a plurality of light source modules connected one to the next without using separate components such as wire harnesses; thus, it is possible to obtain a backlight light source with a smaller number of components and reduced cost.

In the backlight light source according to one embodiment of the invention, at least one of the plurality of light source modules has light sources emitting a different amount of light from the light sources of the other light source modules.

According to the above-described embodiment, by combining together light source modules that are different from one another in the amount of light their respective light sources emit, it is possible to obtain a backlight light source with a well-balanced light amount as a whole. Thus, it is possible to employ, without wasting, a plurality of light source modules that vary in the amount of light their light sources emit, and thus to achieve cost reduction in backlight light sources.

In the backlight light source according to one embodiment of the invention, the plurality of light source modules linearly connected together are disposed to face a side surface of a light guide plate.

According to the above-described embodiment, by letting the light emitted from the backlight light source enter the light guide plate through a side surface thereof and exit it through the front surface thereof, it is possible to build a side-lit backlight device.

In the backlight light source according to one embodiment of the invention, the plurality of light source modules linearly connected together are disposed in a plurality of rows to face the back surface of a diffusion plate.

According to the above-described embodiment, by letting the light emitted from the backlight light source enter the diffusion plate through the back surface thereof and exit it through the front surface thereof, it is possible to build a direct-lit backlight device.

### BRIEF DESCRIPTION OF DRAWINGS

FIG. 1 A diagram showing a light source module according to a first embodiment of the present invention.

FIG. 2A A procedure diagram showing the initial stage of how to connect terminals of a connection substrate to a second connector.

FIG. 2B A diagram showing the stage following that shown in FIG. 2A.

FIG. 2C A diagram showing the stage following that shown in FIG. 2B.

FIG. 3 A diagram showing a light source module as a comparative example.

FIG. 4A A lateral sectional view showing a backlight light source according to a second embodiment of the invention.

FIG. 4B A longitudinal sectional view showing the backlight light source according to the second embodiment.

FIG. 5A A lateral sectional view showing a backlight light source according to a third embodiment of the invention.

FIG. 5B A longitudinal sectional view showing the backlight light source according to the third embodiment.

### LIST OF REFERENCE SYMBOLS

1 Light source module
11 Mounting substrate
12 Connection substrate
13a, 13b Conductors
14a, 14b Terminals
15 First connector
16 Second connector
16a, 16b Terminal electrodes of a second connector
18 LED

### BEST MODE FOR CARRYING OUT THE INVENTION

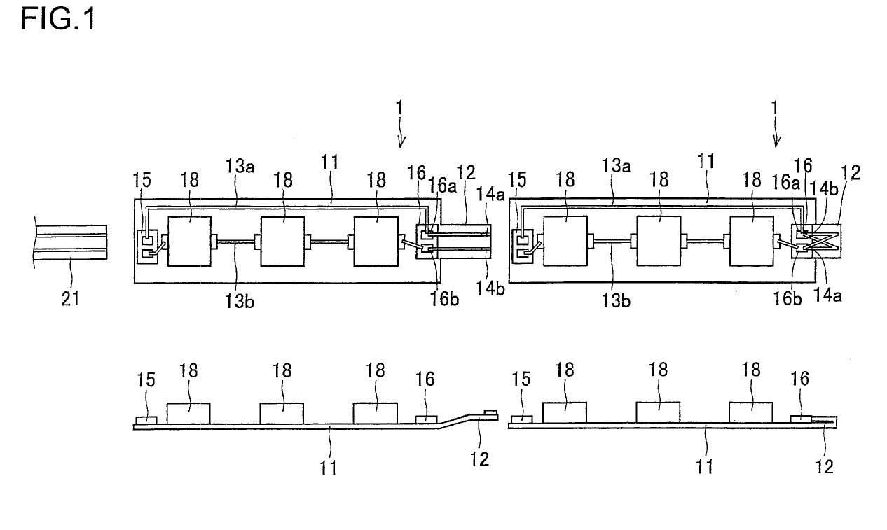

FIG. 1 is a diagram schematically showing a light source module as a first embodiment of the present invention, showing the light source module in a plan view and a side view put together. FIG. 1 shows two light source modules before they are connected to each other.

As shown in FIG. 1, the light source module 1 is provided with: a mounting substrate 11 and a connection substrate 12 formed integral with each other; two conductors 13a and 13b formed on the mounting substrate 11 and the connection substrate 12; terminals 14a and 14b located in a tip part of the connection substrate 12 and formed at one end of the two conductors 13a and 13b respectively; a first connector 15 connected to the other end of the conductors 13a and 13b; and a second connector 16 connected to the one end of the conductors 13a and 13b. On the mounting substrate 11, three LEDs 18, 18, 18 are mounted and each of them is connected to a single conductor 13b in series. The LEDs 18 are all white light emitting LEDs.

The mounting substrate 11 and the connection substrate 12 are formed of a flexible material such as polyimide. Compared with the mounting substrate 11, the connection substrate 12 is smaller both in the length direction and in the width direction; on the other hand, the thicknesses of the connection substrate 12 and the mounting substrate 11 are the same. The conductors 13a and 13b are formed as strips of conductive foil such as copper foil printed on the surface of the mounting substrate 11 and the connection substrate 12. The first connector 15 is mounted on the surface of the mounting substrate 11 at the other end thereof, and is a top-contact connector used for connection with so called FFCs (flexible flat cables). The second connector 16 is mounted on the surface of the mounting substrate 11 at one end thereof, and, like the first connector 15, is a top-contact connector. The second connector 16 is connected to both of the conductors 13a and 13b, and is located between a mounting substrate 11-side part and a connection substrate 12-side part of the conductors 13a and 13b. The second connector 16 has two terminal electrodes 16a and 16b connected to the two conductors 13a and 13b respectively.

Using a plurality of light source modules 1 with the structure described above makes it possible to form a linear backlight light source without using other components such as cables. Specifically, in FIG. 1, the connection substrate 12 of one light source module 1 is connected to the first connector 15 of the other light source module 1, so that the conductors 13a and 13b of the two light source modules 1 are electrically connected together.

The connection substrate 12 of the other light source module 1 is folded to be connected to the second connector 16 on the mounting substrate 11 integral with itself. Here, in the second connector 16, so that the terminals 14a and 14b of the two conductors 13a and 13b are reversely connected to the terminal electrodes 16a and 16b of the conductors 13a and 13b, the connection substrate 12 is folded with its opposite sides in the width direction reversed. This allows the two conductors 13a and 13b to connect to each other. Note that in FIG. 1, for the other light source module 1, the conductors 13a and 13b on the connection substrate 12 and the paths of the terminals 14a and 14b, and how the terminals 14a and 14b and the terminal electrodes 16a and 16b are connected on the second connector 16 are shown accurately but the folded shape of the connection substrate 12 is shown in a simplified form.

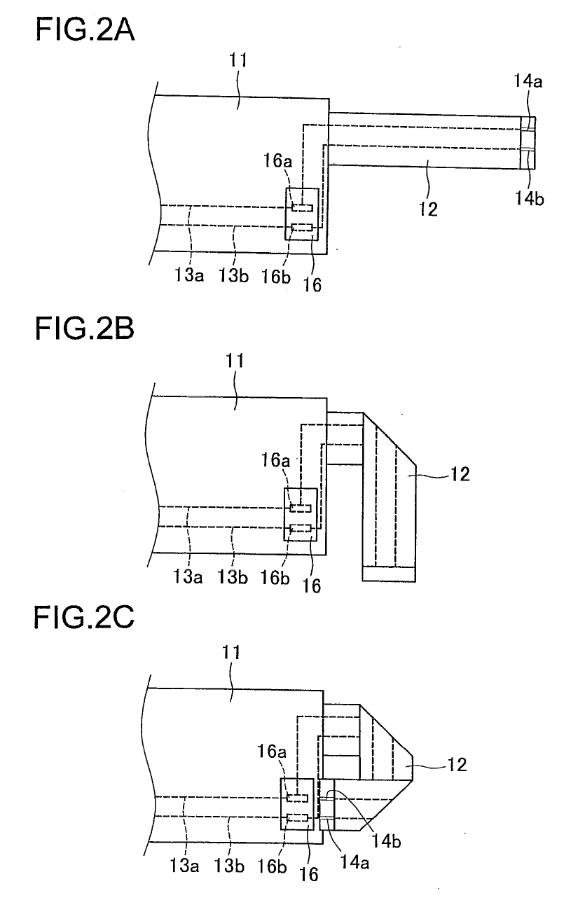

FIGS. 2A to 2C are procedure diagrams showing, stage by stage, how the connection substrate 12 of the other light source module 1 is folded and connected to the second connector 16. In FIGS. 2A to 2C, the conductors 13a and 13b are represented by broken lines. A tip part of the connection substrate 12, which has, at the tip thereof, the terminals 14a and 14b connected to the conductors 13a and 13b as shown in FIG. 2A, is folded substantially at a right angle as shown in FIG. 2B. Then, as shown in FIG. 2C, the tip part of the connection substrate 12 is once again folded at a right angle to be connected to the second connector 16. In this way, the terminal 14a connected to the conductor 13a is reversely connected to the terminal electrode 16b of the second connector 16, and the terminal 14b connected to the conductor 13b is reversely connected to the terminal electrode 16a of the second connector 16. This makes it possible to electrically connect the two conductors 13a and 13b by the second connector 16.

Thus, by connecting the two conductors 13a and 13b with each other by the second connector 16 of the other light source module 1, it is possible to connect in series the conductors 13a and 13b, which are each connected one to the next among a plurality of light source modules 1. Thus, by simply connecting the first connector 15 of one light source module 1 to an LED driver circuit, via an FFC for example, it is possible to connect the LEDs 18 of the plurality of light source modules 1 to the driver circuit (unillustrated).

As described above, according to this embodiment, two adjacent light source modules 1 can be connected with each other without using an extra component such as a wire harness or an FFC. Furthermore, for the other light source module 1, by connecting the connection substrate 12 to the second connector 16, it is possible to connect the two conductors 13a and 13b with each other without using an extra component. Thus, with the light source module 1 alone, i.e. with a smaller number of components, a backlight light source can be formed.

In a case where a plurality of light source modules 1 are linearly arrayed, although the second connector 16 is not used except in the light source module 1 at the terminal end, the use of one kind of light source module 1 makes it possible, by the mass-production effect, to reduce the cost of the light source modules 1. Moreover, as will be described later, when the positions of the light source modules 1 are adjusted according to the light amount of the LEDs 18, any of the light source modules 1 can be disposed either at the terminal end or at any other position along the way and thus there is no restriction on their position; thus it is possible to enhance flexibility in adjustment and in addition reduce a waste of light source modules 1. Moreover, it is possible to cope with defective products and failures easily.

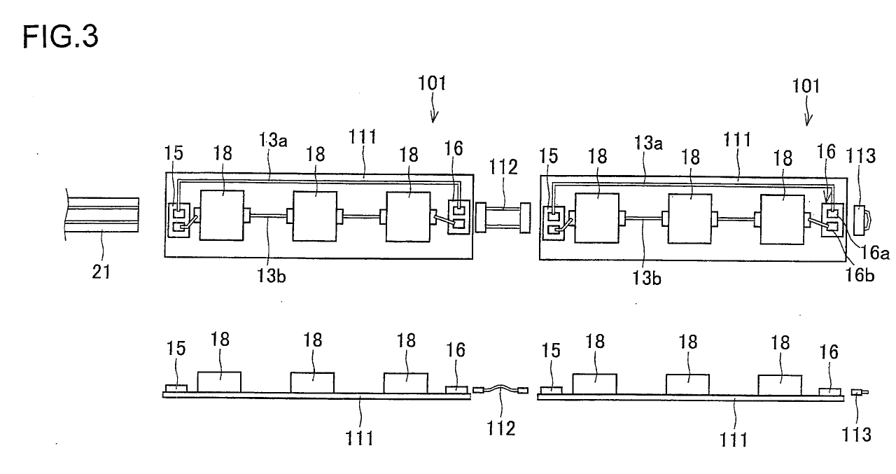

FIG. 3 is a diagram showing a light source module as a comparative example; except that the mounting substrate has no connection substrate, this light source module has substantially the same structure as that of the first embodiment. In the light source module of the comparative example, such parts as find their counterparts in the first embodiment are identified by common reference signs. As shown in FIG. 3, to connect a plurality of light source modules 101 of the comparative example, between two adjacent light source modules 101, the first connector 15 and the second connector 16 need to be connected together with a separate connection cable 112. Furthermore, in the other light source module 101, to connect two conductors 13a and 13b with each other, a terminal cable 113 that connects together the terminal electrodes 16a and 16b of the second connector 16 needs to be connected to the second connector 16. Thus, in the comparative example, other than the light source modules 101, a separate connection cable 112 and a separate terminal-end cable 113 are needed, leading to an increased number of components and hence to increased cost.

In contrast, according to the first embodiment, a plurality of light source modules 1 can be connected together without using an extra component, and also a plurality of conductors can be connected with each other in the light source module at the terminal end; thus, it is possible to obtain a backlight light source with a smaller number of components and reduced cost.

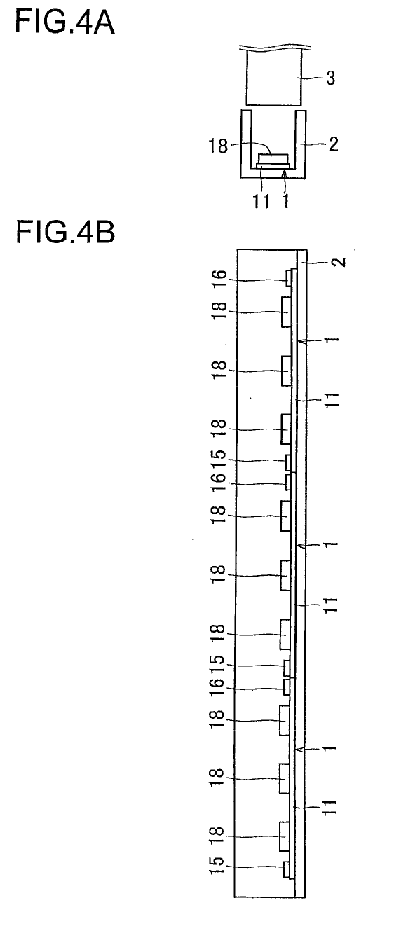

FIG. 4A is a lateral sectional view showing a backlight light source as a second embodiment of the present invention; FIG. 4B is a longitudinal sectional view of the backlight light source shown in FIG. 4A. The backlight light source according to this embodiment is formed by use of the light source module according to the first embodiment, and is used for side-lid backlight devices.

The backlight light source is provided with a plurality of light source modules 1 that are linearly connected and a reflector 2 that houses the plurality of light source modules 1. The reflector 2 has an opening at the top, and the inside surface thereof is formed into a reflection surface to reflect the light emitted from LEDs 18. The reflector 2 is disposed with its opening facing a side surface of a light guide plate 3, so that the light emitted from the LEDs 18 of the light source modules 1 passes through the opening and enters the light guide plate 3 through the side surface thereof. Note that the light guide plate is not shown in FIG. 4B.

The plurality of light source modules 1 inside the reflector 2 are linearly connected, with the connection substrate 12 of one light source module 1 connected to the first connector 15 of the next. Of the plurality of light source modules 1, the one at the terminal end has its connection substrate 12 (see FIG. 2) folded to be connected to the second connector 16. In this way, all of the LEDs 18 of the light source modules 1 are connected in series to form a single circuit. Of the plurality of the light source modules 1, the one at the starting end is connected to an LED driver circuit via an FFC 21 (see FIG. 1) connected to the first connector 15.

In the backlight light source according to this embodiment, the light amount of the LEDs 18 of at least one of the plurality of light source modules 1 differs from the light amount of the LEDs 18 of the other light source modules 1. Specifically, a light source module 1 having LEDs 18 with a larger light amount is disposed at the center, and, on both sides of it, light source modules 1 having LEDs 18 with a smaller light amount are connected. In this way, it is possible to adjust the amount of light that enters the light guide plate 3 appropriately.

The light amount of the LEDs 18 tends to vary; however, this backlight light source is formed by using a plurality of light source modules 1 of one kind, and thus, by adjusting the positions of the light source modules according to the light amount of the LEDs 18 of each light source module 1, it is possible to achieve a proper balance of the light amount in the entire backlight light source.

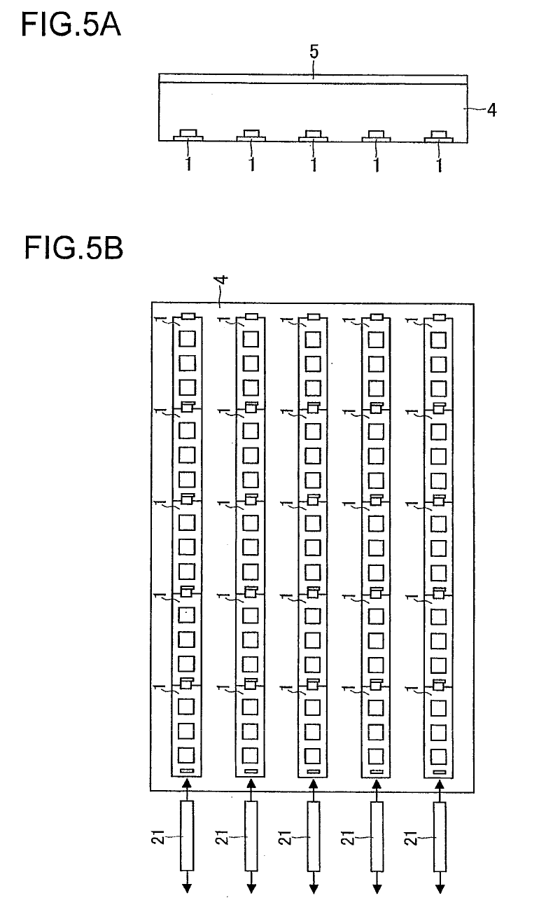

FIG. 5A is a lateral sectional view showing a backlight light source as a third embodiment of the present invention; FIG. 5B is a longitudinal sectional view of the backlight light source shown in FIG. 5A. The backlight light source according to this embodiment is formed by use of the light source module according to the first embodiment, and is used for direct-lit backlight devices.

The backlight light source is provided with a box-shaped backlight case 4, a plurality of light source modules 1 disposed in a bottom part of the backlight case 4, and a diffusion plate 5 provided in a top, open part of the backlight case 4. In the bottom part of the backlight case 4, a plurality of light source modules 1 connected linearly are disposed in a plurality of rows. The structure here is such that the light emitted from LEDs 18 of the plurality of light source modules 1 is diffused by the diffusion plate 5 and enters a liquid crystal display panel disposed on the front. Note that the diffusion plate is not shown in FIG. 5B.

Also in the backlight light source according to this embodiment, as in the backlight light source according to the second embodiment, the plurality of light source modules 1 are linearly connected, with the connection substrate 12 of one light source module 1 connected to the first connector 15 of the next, and in addition the connection substrate 12 of the light source module 1 at the terminal end is connected to the second connector 16. The first connector 15 of the light source module 1 located at the starting end of each row is connected to an LED driver circuit via an FFC 21.

Also in the backlight light source according to this embodiment, by adjusting the positions of the plurality of light source modules according to the light amount of the LEDs 18 of the light source modules, it is possible to achieve a proper distribution of the light amount in the entire diffusion plate 5.

Although the plurality of LEDs 18 of the light source module 1 are all the same white light emitting LEDs in the embodiments described above, it is also possible to use LEDs in different colors. When, for example, LEDs in three different colors, namely red, green, and blue, are mounted on a mounting substrate 11, three sets of conductors are required, complicating the wiring between the mounting substrates 11 when they are connected together with wiring harnesses. In contrast, according to the present invention, by forming three sets of conductors on one connection substrate 12 integral with the mounting substrate 11, it is possible to easily connect two light source modules 1 together with one connection substrate 12.

Moreover, although the plurality of conductors 13a and 13b are connected with each other with the connection substrate 12 of the light source module 1 at the terminal end folded, with the positions of the terminals 14a and 14b reversed, to be connected to the second connector 16, it is also possible to connect the conductors 13a and 13b with each other with the positions of the terminal electrodes 16a and 16b of the second connector 16 changed. For example, instead of the second connector 16 shown in FIG. 1, a reverse connector in which the positions of the terminal electrodes 16a and 16b are reversed is mounted, and, to this reverse connector, the connection substrate 12 is connected simply bent. In this way, it is possible to reversely connect the terminals 14a and 14b of the connection substrate 12 to the terminal electrodes 16a and 16b, so that the conductors 13a and 13b are connected with each other.

### INDUSTRIAL APPLICABILITY

The present invention finds applications in light source modules and backlight light sources included in liquid crystal display devices such as liquid crystal televisions and liquid crystal monitors; in particular, when applied to backlight devices employing LEDs as light sources, the invention makes it easy to assemble products and replace LEDs, and thus increases yields.

1. A light source module comprising:
a mounting substrate having a conductor;
a plurality of light sources mounted on the mounting substrate and connected to the conductor;
a connection substrate formed integral with the mounting substrate and having a terminal connected to one end of the conductor; and
a first connector mounted on the mounting substrate and connected to the other end of the conductor, the first connector permitting, to be connected thereto, a connection substrate shaped identically with the connection substrate.

2. The light source module according to claim 1,
wherein the mounting substrate and the connection substrate are flexible.

3. The light source module according to claim 2,
wherein the mounting substrate has, as the conductor, a plurality of conductors, and
wherein a second connector is provided that permits the connection substrate formed integral with the mounting substrate to be connected to the plurality of conductors somewhere therealong.

4. The light source module according to claim 1,
wherein the light sources are LEDs.

5. A backlight light source comprising, as the light source module, a plurality of light source modules according to claim 1,
wherein the plurality of light source modules are so formed as to be linearly connected together with the connection substrate and the first connector connected together between every two adjacent light source modules.

6. The backlight light source according to claim 5,
wherein at least one of the plurality of light source modules has light sources emitting a different amount of light from the light sources of the other light source modules.

7. The backlight light source according to claim 5,
wherein the plurality of light source modules linearly connected together are disposed to face a side surface of a light guide plate.

8. The backlight light source according to claim 5,
wherein the plurality of light source modules linearly connected together are disposed in a plurality of rows to face a back surface of a diffusion plate.

9. A backlight light source comprising, as the light source module, a plurality of light source modules according to claim 2,
wherein the plurality of light source modules are so formed as to be linearly connected together with the connection substrate and the first connector connected together between every two adjacent light source modules.

10. A backlight light source comprising, as the light source module, a plurality of light source modules according to claim 3,
wherein the plurality of light source modules are so formed as to be linearly connected together with the connection substrate and the first connector connected together between every two adjacent light source modules.

11. A backlight light source comprising, as the light source module, a plurality of light source modules according to claim 4,
wherein the plurality of light source modules are so formed as to be linearly connected together with the connection substrate and the first connector connected together between every two adjacent light source modules.

12. The backlight light source according to claim 9,
wherein at least one of the plurality of light source modules has light sources emitting a different amount of light from the light sources of the other light source modules.

13. The backlight light source according to claim 9,
wherein the plurality of light source modules linearly connected together are disposed to face a side surface of a light guide plate.

14. The backlight light source according to claim 9,
wherein the plurality of light source modules linearly connected together are disposed in a plurality of rows to face a back surface of a diffusion plate.

15. The backlight light source according to claim 10,
wherein at least one of the plurality of light source modules has light sources emitting a different amount of light from the light sources of the other light source modules.

16. The backlight light source according to claim 10,
wherein the plurality of light source modules linearly connected together are disposed to face a side surface of a light guide plate.

17. The backlight light source according to claim 10,
wherein the plurality of light source modules linearly connected together are disposed in a plurality of rows to face a back surface of a diffusion plate.

18. The backlight light source according to claim 11,
wherein at least one of the plurality of light source modules has light sources emitting a different amount of light from the light sources of the other light source modules.

19. The backlight light source according to claim 11,
wherein the plurality of light source modules linearly connected together are disposed to face a side surface of a light guide plate.

20. The backlight light source according to claim 11,
wherein the plurality of light source modules linearly connected together are disposed in a plurality of rows to face a back surface of a diffusion plate.
